(19) United States
(12) Patent Application Publication
(10) Pub. No.: US 2009/0304937 A1
(43) Pub. Date: Dec. 10, 2009

(54) Compositions and Method for Coating Metal Surfaces With an Alkoxysilane Coating

(76) Inventor: Philip John Morgan, New South Wales (AU)

Correspondence Address: NIXON & VANDERHYE, PC, 901 NORTH GLEBE ROAD, 11TH FLOOR, ARLINGTON, VA, 22203, US

(21) Appl. No.: 11/990,438

(22) PCT Filed: Aug. 22, 2006
(86) PCT No.: PCT/GB2006/003131

§ 371 Date: Feb. 14, 2008

(30) Foreign Application Priority Data
Aug. 31, 2005 (EP) 05255330.2
Sep. 2, 2005 (EP) 05255375.7

(51) Int. Cl. B05D 3/00; C09D 105/00

(52) U.S. Cl. 427/384; 106/217.7; 106/15.05

(57) ABSTRACT

An aqueous composition consisting of: (i) an alkyl polysaccharide surfactant; (ii) an alkoxysilane selected from the group consisting of γ-amino propyl triethoxysilane and γ-glycidoxypropyl trimethoxysilane; (iii) water; (iv) optionally alcohol, solely from hydrolysis of the alkoxysilane; and (v) optionally, one or more components selected from the group consisting of biocides, antifoams and adhesion promoters, and its use in a method of coating a metal surface with a silane coating, which method comprises (A) contacting a metal surface with the composition to deposit the alkoxysilane on the metal and (B) drying the metal surface with the alkoxysilane deposited thereon, to produce on the metal surface, a coating comprising a hydrophobic, interlocking network of covalent siloxane bonds. The coated metal is resistant to corrosion.

The present invention relates to compositions for coating metals and to methods for their use and in particular, to silane-containing compositions.

Most metals are susceptible to corrosion, including the formation on the surface of the metal of various types of rust. Such corrosion can affect the quality of the metal; reducing its value, worsening its appearance and decreasing customer satisfaction. Although rust may be removed, such removal can be costly and may reduce the strength of the metal. Also, corrosion may cause loss of adhesion to the metal of coatings such as paints, adhesives and/or rubbers.

Methods of coating steel to reduce corrosion are known.

Thus, Chil, T. F. and Van Ooij, W. J. in “Application of Silane Technology to prevent Corrosion of Metals and improve Paint Adhesion” Transactions of the institute of Metal Finishing, Maney Publishing, Birmingham GB, vol. 77 no. Part 2, March 1999 (1999-03) page 64-70 describes silane treatments of metals.

U.S. Pat. No. 4,828,616 relates to an aqueous surface treatment composition comprising (a) an alkali metal silicate, (b) amino alcohol and (c) a water-soluble resin selected from the group consisting of water soluble nylon, a natural polysaccharide and a water-soluble, natural protein and/or a water-soluble silane coupling agent.

WO 01/07680 relates to an aqueous composition for an anti-corrosion treatment of a metal substrate pre-treated with a zinc-based protective coating, which is an aqueous silane-based solution containing water, silane, boric acid and phosphoric acid, micronized silica and a wetting agent.

U.S. Pat. No. 5,108,793 relates to a method of coating steel with a corrosion resistant coating by rinsing the steel with an alkaline aqueous solution having an elevated temperature and including corrosion resistant amounts of a silicate and a metal, drying the steel to form a relatively insoluble silicate coating and then rinsing the silicate coated sheet in another aqueous solution which includes a corrosion resistant amount of a silane. According to U.S. Pat. No. 5,108,793, the sheet may be rinsed for at least 10 seconds with the silane solution containing at least 1.0 vol % silane. Possible silanes are said to include γ-glycidoxypropyl trimethoxysilane (GPS), γ-amino propyl tri(m)ethoxysilane (APS), γ-methacryloxypropyltrimethoxysilane (MPS) and N-[2-vinylbenzylamino)ethyl]-3-aminopropyl trimethoxysilane (BPS), with APS and BPS being preferred. The silane is said to be dissolved into an aqueous solution in concentrations of 0.5-5 vol. % by being acidified.

U.S. Pat. No. 5,292,549 relates to steel sheet coated with a thin film of siloxane for suppressing rust. According to U.S. Pat. No. 5,292,549 several artisans have proposed rinsing galvanised steel in a bath containing up to about 10 wt. % of silane coupling agent prior to painting. Silanes proposed have said to include aminopropyl trimethoxy, aminopropyl triethoxy, methacryloxy propyl trimethoxy and glycidoxypropyl trimethoxy. It is said that the rinsed steel may be baked at an elevated temperature to form a hardened or permanent thick silane coating, which may be difficult to remove.

The invention of U.S. Pat. No. 5,292,549 is said to include a metallic coated steel sheet having a thin siloxane film which is the cured reaction product formed by rinsing the metallic coated steel sheet with an organic silane and a crosslinking agent. Experiments are described in which solutions containing silane with and without crosslinking agent are used. Amino silanes are said to perform well with γ-amino propyl trialkoxy silane (APS) being the most preferred. Examples of other silanes which can be used are said to be γ-glycidoxypropyl trimethoxy (GPS), γ-methacryloxypropyltrimethoxy, mercaptopropyltrimethoxy or N-[2-vinylbenzylamino)ethyl]-3-aminopropyl trimethoxy (SAAPS) silane.

US published patent application US 2005/058843 relates to a method of treating a metal surface particularly of zinc and zinc alloys to provide a metal surface having improved corrosion resistance. The method comprises the steps of applying a silane solution to the metal surface, the silane solution having at least one vinyl silane and at least one bis-silyl aminosilane which have been at least partially hydrolysed.

According to US 2005/058843, the silane compounds may be provided as a solution (preferably aqueous solution). According to US2005/058843, the vinyl silane(s) and aminosilane(s) in the solution are at least partially hydrolysed and preferably are substantially fully hydrolysed in order to facilitate bonding of the silanes to the metal surface and to each other. According to US 2005/058843, during hydrolysis, the —OR¹ groups are replaced by hydroxyl groups. Hydrolysis is said to be accomplished, for example, by merely mixing the silanes with water and optionally including a solvent (such as an alcohol) in order to improve silane solubility and solution stability.

According to US 2005/058843, the solubility in water of some suitable silanes may be limited, so the treatment solution may optionally include one or more solvents (such as an alcohol) in order to improve silane solubility. Particularly preferred solvents are said to include: methanol, ethanol, propanol, and iso-propanol. It is stated that since it is often desirable to limit, or even eliminate the use of organic solvents wherever possible, the solution is said to be more preferably aqueous in nature, thereby having less than 5 parts organic solvent for every 5 parts of water (i.e. more water than solvent). The solutions it is said, can even be substantially free of any organic solvent and when a solvent is used, ethanol is said to be preferred.

WO01/06036 relates to a method of treating a metal surface by applying a solution comprising (i) at least one acyloxy silane which comprises at least one acyloxy group, wherein said silane has been at least partially hydrolysed, and (ii) at least one basic compound, wherein the acyloxy silane and the basic compound are present in concentrations to provide a solution pH of between about 3 and about 10 and wherein the solution is substantially free of acid other than acid produced upon hydrolysis of the acyloxy silane. It is stated that the treatment solution may optionally include one or more compatible solvents (such as ethanol, methanol, propanol or isopropanol) although their presence is not normally required. It is also stated that when an organic solvent is required ethanol is preferred and that preferably, solutions are substantially free of organic solvents and VOCs. VOC is understood to mean Volatile Organic Compound. According to WO 01/06036, the acyloxy silanes generally dissolve and hydrolyse readily and completely in water to produce organic acids, unlike the analogous alkoxy silanes which are said to produce alcohols on hydrolysis.

The use of solvents is disadvantageous because it can cause problems of flammability of the solution. There remains a need for an alternative solution for coating metal surfaces.

Thus, according to the present invention there is provided an aqueous composition consisting of:
(i) an alkyl polysaccharide surfactant;
(ii) an alkoxysilane selected from the group consisting of γ-amino propyl triethoxysilane and γ-glycidoxypropyl trimethoxysilane;
(iii) water;
(iv) optionally alcohol, solely from hydrolysis of the alkoxysilane; and
(v) optionally, one or more components selected from the group consisting of biocides, antifoams and adhesion promoters.

Also, according to the present invention, there is provided a method of coating a metal surface with a silane coating, which method comprises:

(A) contacting a metal surface with a composition consisting of:
(i) an alkyl polysaccharide surfactant;
(ii) an alkoxysilane selected from the group consisting of γ-amino propyl triethoxysilane and γ-glycidoxypropyl trimethoxysilane;
(iii) water;
(iv) optionally alcohol, solely from hydrolysis of the alkoxysilane; and
(v) optionally, one or more components selected from the group consisting of biocides, antifoams and adhesion promoters,
to deposit the alkoxysilane on the metal surface and
   (B) drying the metal surface with the alkoxysilane deposited thereon, to produce on the metal surface a coating comprising a hydrophobic, interlocking network of covalent siloxane bonds.

The present invention solves the technical problem defined above, by the use in an aqueous composition, of an alkyl polysaccharide surfactant in combination with one of two alkoxysilanes.

The present invention does not require the metal surface to be coated with a silicate coating, for example such as described in U.S. Pat. No. 5,108,793.

The present invention does not require the use of a cross-linking agent, for example such as described in U.S. Pat. No. 5,292,549.

The composition of the present invention does not require the presence of alcohol in addition to that (if any) which might be formed by hydrolysis of the alkoxysilane.

The alkyl polysaccharide may be an alkyl polyglucoside. The alkyl group may be a C₈-C₁₀ alkyl group or a C₁₀-C₁₆ alkyl group. The alkyl polysaccharide may be an alkyl polyglucoside in which the alkyl group is a C₈-C₁₀ alkyl group, for example as is commercially available as Berol AG 6212 (trade mark). Preferably, the alkyl polysaccharide is an alkyl polyglucoside in which the alkyl group is a C₁₀-C₁₆ alkyl group, for example as is commercially available as Alkadet 15 (trade mark). Another commercially available alkyl polyglucoside which may be used are Alkadet 20 (trade mark).

The γ-amino propyl triethoxysilane is available commercially as Silquest A110 (trade mark). The γ-glycidoxypropyl trimethoxysilane is available commercially as Silquest A187 (trade mark). Both of these alkoxysilanes are available as liquids without solvent.

The pH of the aqueous composition of the present invention is dependent upon the alkoxysilane used. γ-amino propyl triethoxysilane has tendency to hydrolyse at a pH of between 8 and 11 inclusive. γ-glycidoxypropyl trimethoxysilane has a tendency to hydrolyse at a pH of between 5.5 and 6.5 inclusive. Therefore, these two alkoxysilanes are not used together.

In the composition of the present invention, the alkoxysilane is suitably present at a concentration of up to 10% by weight, preferably at a concentration of up to 5% by weight. Preferably, the alkoxysilane is present in the composition of the present invention at a concentration of 1 to 10% by weight, preferably at a concentration in the range of 2 to 4% by weight.

In the composition of the present invention, the surfactant is suitably present at a concentration of up to 10% by weight, preferably at a concentration of up to 5% by weight and more preferably at a concentration in the range of up to 1% by weight. Preferably, the surfactant is present in the composition of the present invention at a concentration in the range 0.05% by weight to 10% by weight. Preferably de-ionised water is used in the composition of the present invention.

The composition of the present invention may contain one or more components selected from the group consisting of biocides, antifoams and adhesion promoters.

Biocides are known in the art. The composition of the present invention may contain one or more biocides at an effective concentration. The one or more biocides may be present in the composition of the present invention at a concentration of up to 1000 ppm by weight.

Antifoams are known in the art. The composition of the present invention may contain one or more antifoam at an effective concentration. The concentration of the one or more antifoams in the composition of the present invention may depend upon the surfactant used. Thus for example, some surfactants require less antifoam that others. The one or more antifoams may be present in the composition of the present invention at a concentration of up to 1% by weight.

One or more adhesion promoters may be present in the composition of the present invention to promote adhesion of paint and the like to the coated metal. Adhesion promoters are known in the art of paint technology. The type of adhesion promoter used, may depend upon the metal being coated. Suitable adhesion promoters may be polyester based. A suitable polyester based adhesion promoter is N20820 available from BYK. The one or more adhesion promoters may be present in the composition of the present invention at a concentration of 1-5% by weight.

The aqueous composition of the present invention may be prepared by mixing the components together in any sequence. Suitably, the components are introduced into a mixer in the following sequence: surfactant, alkoxysilane, water. Alternatively, the water may be introduced into a mixer first followed by the alkoxysilane then surfactant or surfactant then alkoxysilane. The optional other components (one or more components selected from the group consisting of antifoams, biocides and adhesion promoters) may be added to the composition at any stage in the preparation and are suitably added after the surfactant, alkoxysilane and water have been mixed together. Preferably, the water is introduced into a mixer first followed by the alkoxysilane then surfactant and then followed by the optional other components (one or more components selected from the group consisting of antifoams, biocides and adhesion promoters). The composition may be prepared by mixing the components together at ambient temperature.

In the method of the present invention, the metal surface may be contacted with the composition by passing the metal surface through a bath containing the composition or by spraying the composition onto the metal surface. Spraying is preferred for an industrial scale method. The metal surface may be contacted with the composition for a contact time of 1 to 10 seconds, preferably 4 to 6 seconds, for example 5 seconds. Preferably, the metal surface is contacted with the composition at a temperature of no greater than 60° C., preferably at a temperature no greater than a maximum temperature in the range 20 to 60° C. Preferably, the metal surface is contacted with the composition for a contact time of 5 seconds at a temperature of 55° C.

In step (B) of the method of the present invention, the metal surface with the alkoxysilane deposited thereon, is dried to produce on the metal surface, a coating comprising a hydrophobic, interlocking network of covalent siloxane bonds.

In step (B) the surface metal with the alkoxysilane deposited thereon, is preferably dried for a time period in the range 1 hour to 120 hours to produce on the metal surface, a coating comprising a hydrophobic, interlocking network of covalent siloxane bonds.

In step (B) the surface metal deposited with alkoxysilane deposited thereon, is preferably dried at a temperature in the range 15 to 100° C.

Heating in step (B) is not essential but it reduces the drying time. Preferably, in step (B) the metal surface with the alkoxysilane deposited thereon, is heated at a temperature of 80 to 90° C. Suitably, the metal surface may be heated in a furnace operating at a temperature of 80 to 90° C., with the metal surface passing through at a rate to give a residence time of 1 to 60 minutes, preferably 3 to 10 minutes, for example about 5 minutes.

Suitable metal surfaces for coating with the composition in the method of the present invention include carbon steel and galvanised steel. Suitably, the galvanised steel is hot dipped galvanised steel. Examples of suitable galvanised steel are Zincanneal and Galvanneal. Compositions according to the present invention in which the alkoxysilane is γ-amino propyl triethoxysilane are particularly suitable for use with carbon steel. Compositions according to the present invention in which the alkoxysilane is γ-glycidoxypropyl trimethoxysilane are particularly suitable for use with galvanised steel.

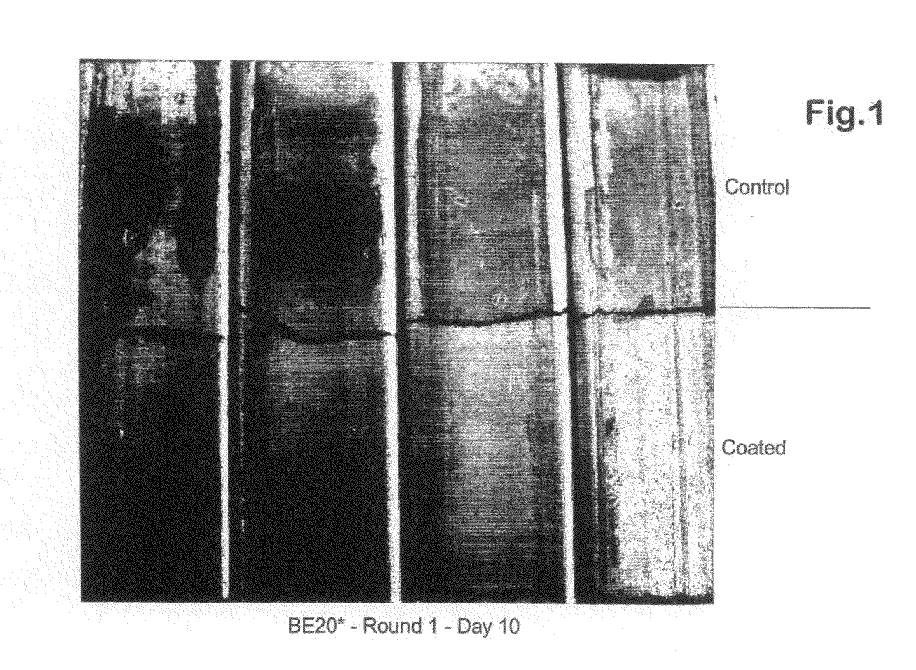

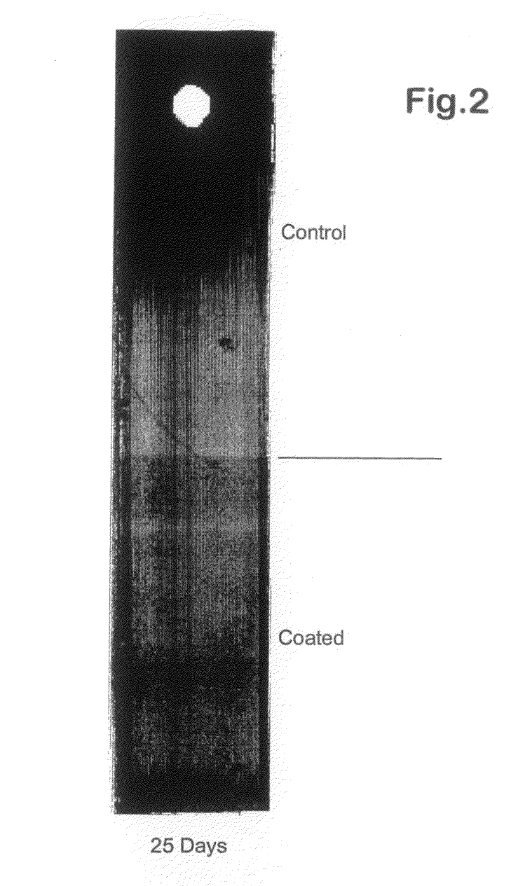

The invention will now be described by reference to the following examples and with reference to FIGS. 1 and 2 in which

FIG. 1 shows galvanised steel tubes on day 10 of a test and

FIG. 2 shows the surface of carbon steel on day 25 of a test.

It was found that without any surfactant present in the compositions, it was not possible to apply a coating with the alkoxysilanes because the metal surfaces did not wet properly.

Tests were performed with compositions comprising alkyl polysaccharide surfactant.

### Galvanised Steel

Unpassivated, electrogalvanised rectangular steel tubes were used in their “as received” form.

### Cleaning:

Prior to use, the metals were cleaned. For the majority of experiments, each galvanized steel tube was cleaned in an ultrasonic bath for 1 hour (to remove loose dirt and steel particles), allowed to dry, and then cleaned with n-heptane followed by acetone.

The metal tubes were alkaline cleaned by the following steps:
Soaking in aromatic hydrocarbon solvent for 15 minutes to remove any grease or oil that may be present on the metal surface;
Cleaning in an ultrasonic bath (deionised water and Alkadet 15 surfactant) for 2-3 minutes to loosen any particulates and were then rinsed under with tap water to remove any particulates;
Dipping in 1% caustic soda or 3% sodium tripolyphosphate (STPP), for 5 seconds;
Rinsing with tap water, and
Drying with a clean paper towel.

The alkaline cleaning was done to activate the hydroxy groups on the surface of the metal, which could increase adsorption of the silane on the surface and provide better film formation and increase rust protection.

Contacting the Metal Surface with the Composition and Drying:

The composition was prepared by introducing to a mixing beaker in the following sequence: 0.5% by weight Alkadet 15 (trade mark) surfactant; 3% by weight γ-glycidoxypropyl trimethoxysilane (Silquest A187 supplied by GE Silicones) and 96.5% by weight deionised water. The components were mixed in the beaker and the resultant composition was set aside for use. The composition had a pH ranging 6.5 to 7.0.

Since the thickness of the silane film was found not to be dependent on contact time, 5 seconds was chosen as a sufficient contact time between the composition and the metal.

Each clean, dry tube was dipped in the composition, up to halfway, for 5 seconds, and allowed to dry at room temperature (approximately 22° C.) for 42-72 hours, unless otherwise specified. The top, un-coated, half of the galvanized steel tube acted as a control for rust testing.

The drying step was found to produce an optimal coating comprising a hydrophobic, interlocking network of covalent siloxane bonds. Although 42-72 hours, at room temperature was a sufficient drying time, increased temperatures would decrease drying time.

### Corrosion Testing:

Corrosion testing was done using a test similar to the American Standard Test Method (ASTM) D1748, the Humidity Cabinet test, with the silane coated steel tubes being placed in a closed, high humidity environment. The test differed from the ASTM method in the use of sealed plastic containers instead of humidity cabinets and the use of a saturated copper sulphate slurry to provide the humidity instead of a bath as specified by ASTM D1748.

The clean, coated galvanized steel tubes were sprayed with de-ionised water and stacked together in groups of four, secured with a rubber band (Some were stacked 1×4 and some were stacked 2×2). The stacked panels were placed in a sealed plastic container containing a saturated copper sulphate slurry, and the contact sides of the tubes were observed daily for the appearance of white rust (Those tubes stacked 2×2 had two contact sides). Every day that there was no rust observed the tubes were re-sprayed with de-ionised water, and testing continued.

It was found that no rust was observed on the coated parts of the tubes on each of the first 9 days of the test. On the tenth day of the test, white rust was observed on the coated part of the tubes. FIG. 1 is a photograph of test pieces showing the white rust on the upper (uncoated) parts of the tubes (control) and on the lower (coated) parts of the tubes on day 10 of the test.

### Cold Rolled Steel, Prepared as Cold Rolled Steel

Unpolished, Cold Rolled Steel (CRS) from ACT Laboratories Inc, Hillsdale, was cut into 10 cm by 2 cm panels, with a 5 mm hole drilled into the top of each panel for hanging.

### Cleaning:

Prior to contacting with the silane-containing composition, the CRS panels were cleaned thoroughly with n-heptane, allowed to dry, and were then cleaned with acetone until the surface was “water-break free”, which indicated that the surface was completely clean (water did not break around any dirt and/or oil on the surface).

Contacting the Metal Surface with the Composition and Drying:

The composition was prepared by introducing to a mixing beaker in the following sequence: 0.5% by weight Alkadet 15 (trade mark) surfactant; 3% by weight γ-amino propyl triethoxysilane (Silquest A110 supplied by GE Silicones, Dandenong) and 96.5% by weight deionised water. The components were mixed in the beaker and the resultant composition was set aside for use. The composition had a pH ranging 8 to 11.

Since the thickness of the silane film was found not to be dependent on contact time, 5 seconds was chosen as a sufficient contact time.

Each clean, CRS panel was dipped in the composition, up to half way, for 5 seconds, and allowed to dry at room temperature (approximately 22° C.) for 22 hours, unless otherwise specified. The top, un-coated, half of the panel acted as a control for rust testing.

The drying step was found to produce an optimal coating comprising a hydrophobic, interlocking network of covalent siloxane bonds. Although 22 hours, at room temperature was a sufficient drying time, increased temperatures would decrease drying time.

### Corrosion Testing:

Corrosion testing was done using a test similar to the American Standard Test Method (ASTM) D1748, the Humidity Cabinet test, with the silane coated steel tubes being placed in a closed, high humidity environment. The test differed from the ASTM method in the use of sealed plastic containers instead of humidity cabinets and the use of a saturated copper sulphate slurry to provide the humidity instead of a bath as specified by ASTM D1748.

Each silane-coated panel was hung vertically in a sealed plastic container, containing a saturated copper sulphate slurry, and was observed daily for the appearance of red rust. The panels were not re-sprayed each day and there was no metal-to-metal contact (as there was with the tests for the galvanized steel tubes).

It was found that the parts of the carbon steel panels which were coated according to the present invention remained without rust far better and much longer than the uncoated (control) steel. This is shown in FIG. 2 which is a photograph of a steel panel on day 25 of the test. The upper uncoated part of the panel has more rust than the lower coated part.

1-18. (canceled)

19. An aqueous composition consisting of:
(i) an alkyl polysaccharide surfactant;
(ii) an alkoxysilane selected from the group consisting of γ-amino propyl triethoxysilane and γ-glycidoxypropyl trimethoxysilane;
(iii) water;
(iv) optionally alcohol, solely from hydrolysis of the alkoxysilane; and
(v) optionally, one or more components selected from the group consisting of biocides, antifoams and adhesion promoters.

20. A composition as claimed in claim 19 in which the alkyl polysaccharide surfactant is an alkyl polyglucoside.

21. A composition as claimed in claim 19 in which the alkyl group of the alkyl polysaccharide is a C₁₀-C₁₆ alkyl group or a C₈-C₁₀ alkyl group.

22. A composition as claimed in claim 20 in which the alkyl group of the alkyl polysaccharide is a C₁₀-C₁₆ alkyl group or a C₈-C₁₀ alkyl group.

23. A composition as claimed in claim 19 in which the surfactant is present at a concentration in the range 0.05 to 10% by weight.

24. A composition as claimed in claim 22 in which the surfactant is present at a concentration in the range 0.05 to 10% by weight.

25. A composition as claimed in claim 19 in which the alkoxysilane is present at a concentration in the range 1 to 10% by weight.

26. A composition as claimed in claim 23 in which the alkoxysilane is present at a concentration in the range 1 to 10% by weight.

27. A composition as claimed in claim 24 in which the alkoxysilane is present at a concentration in the range 1 to 10% by weight.

28. A composition as claimed in claim 19 in which the surfactant is a C₁₀-C₁₆ alkyl polyglucoside and is present at a concentration of 0.5% by weight, and the alkoxysilane is γ-glycidoxypropyl trimethoxysilane and is present at a concentration of 3% by weight.

29. A composition as claimed in claim 19 in which the surfactant is a C₁₀-C₁₆ ailcyl polyglucoside and is present at a concentration of 0.5% by weight and the alkoxysilane is γ-amino propyl triethoxysilane and is present at a concentration of 3% by weight.

30. A method of coating a metal surface with a silane coating, which method comprises:
(A) contacting a metal surface with a composition consisting of:
(i) an alkyl polysaccharide surfactant;
(ii) an alkoxysilane selected from the group consisting of γ-amino propyl triethoxysilane and γ-glycidoxypropyl trimethoxysilane;
(iii) water;
(iv) optionally alcohol, solely from hydrolysis of the alkoxysilane; and
(v) optionally, one or more components selected from the group consisting of biocides, antifoams and adhesion promoters, to deposit the alkoxysilane on the metal and
(B) drying the metal surface with the alkoxysilane deposited thereon, to produce on the metal surface, a coating comprising a hydrophobic, interlocking network of covalent siloxane bonds.

31. A method as claimed in claim 30 in which the alkyl polysaccharide surfactant is an alkyl polyglucoside.

32. A method as claimed in claim 30 in which the alkyl group of the alkyl polysaccharide surfactant is a C₁₀-C1₆ alkyl group or a C₈-C₁₀ alkyl group.

33. A method as claimed in claim 31 in which the alkyl group of the alkyl polysaccharide surfactant is a C₁₀-C₁₆ alkyl group or a C₈-C₁₀ alkyl group.

34. A method as claimed in claim 30 in which the surfactant is present in the composition at a concentration in the range 0.05 to 10% by weight.

35. A method as claimed in claim 33 in which the surfactant is present in the composition at a concentration in the range 0.05 to 10% by weight.

36. A method as claimed in claim 30 in which the alkoxysilane is present in the composition at a concentration in the range 1 to 10% by weight.

37. A method as claimed in claim 34 in which the alkoxysilane is present in the composition at a concentration in the range 1 to 10% by weight.

38. A method as claimed in claim 35 in which the alkoxysilane is present in the composition at a concentration in the range 1 to 10% by weight.

39. A method as claimed in claim 30 in which the metal surface comprises carbon steel and the alkoxysilane is γ-amino propyl triethoxysilane.

40. A method as claimed in claim 39 in which in the composition, the surfactant is a C₁₀-C₁₆ alkyl polyglucoside and is present at a of 0.5% by weight, and the alkoxysilane is γ-amino propyl triethoxysilane and is present at a concentration of 3% by weight.

41. A method as claimed in claim 30 in which the metal surface comprises galvanized steel and the alkoxysilane is γ-glycidoxypropyl trimethoxysilane.

42. A method as claimed in claim 41 in which in the composition, the surfactant is a C₁₀-C₁₆ alkyl polyglucoside and is present at a concentration of 0.5% by weight, and the alkoxysilane is γ-glycidoxypropyl trimethoxysilane and is present at a concentration of 3.0% by weight.

43. A method as claimed in claim 30 in which the surface metal with the alkoxysilane deposited thereon, is dried at a temperature in the range 15 to 100° C. to produce on the metal surface, a coating comprising a hydrophobic, interlocking network of covalent siloxane bonds.

44. A method as claimed in claim 30 in which the surface metal with the deposited alkoxysilane deposited thereon, is dried for a time period in the range 1 hour to 120 hours to produce on the metal surface, a coating comprising a hydrophobic, interlocking network of covalent siloxane bonds.
